(19) United States
(12) Patent Application Publication
(10) Pub. No.: US 2014/0111526 A1
(43) Pub. Date: Apr. 24, 2014

(54) TERMINAL DEVICE AND DISPLAY APPARATUS

(71) Applicant: CANON KABUSHIKI KAISHA, Tokyo (JP)

(72) Inventor: Takashi Asaka, Hiratsuka-shi (JP)

(73) Assignee: CANON KABUSHIKI KAISHA, Tokyo (JP)

(21) Appl. No.: 14/061,228

(22) Filed: Oct. 23, 2013

(30) Foreign Application Priority Data
Oct. 24, 2012 (JP) 2012-234581

(51) Int. Cl. G09G 5/00

(52) U.S. Cl. CPC G09G 5/006
USPC 345/520

(57) ABSTRACT

A terminal device comprises a first image processing processor, a connection unit, and a control unit. The first image processing processor generates a first image signal from image data. The connection unit is connectable with a display apparatus which includes a second image processing processor for generating a second image signal from the image data. The control unit controls the first image processing processor and the second image processing processor. The control unit selects one of the first image processing processor and the second image processing processor. If the second image processing processor is selected, the control unit instructs the second image processing processor to perform a predetermined process, instructs the first image processing processor to generate the first image signal, and instructs the second image processing processor to generate the second image signal after the predetermined process is completed.

### BACKGROUND OF THE INVENTION

1. Field of the Invention

The present invention relates to a display system, a terminal device, a display apparatus and a control method.

2. Description of the Related Art

There are DP (DisplayPort) and the like, as a standard concerning the transmission of an image signal to a display apparatus from a terminal device such as a PC (Personal Computer).

In addition, there are PCIe (Peripheral Component Interconnect Express) and the like, as a standard concerning the transmission of the signal within an apparatus. For instance, a PCIe bus is used in the inner part of the PC.

An example of a method of displaying an image with the display apparatus will be described below. In the inner part of the PC, a CPU (Central Processing Unit) instructs a GPU (Graphics Processing Unit) to generate an image signal. Then, the GPU generates the image signal in accordance with the above-described instruction, and outputs the generated image signal to the outside of the PC through a DP interface. The image signal which is output from the PC is input into the display apparatus. The display apparatus displays an image based on the input image signal.

Meanwhile, there is Thunderbolt (which will be hereafter referred to as TB) as a standard concerning an interface. The signal of the PCIe and the signal of the DP can be transmitted by one TB cable (see http://www.intel.com/technology/io/thunderbolt/index.htm).

In a display system in which a terminal device is connected with a display apparatus by using the TB cable, the display apparatus can display an image based on the image signal of the DP, which is input from the outside through the TB cable. Furthermore, in a case where the display apparatus has the GPU in the above-described display system, the display apparatus can transmit the signal of the PCIe to the GPU of the display apparatus from the CPU of the terminal device (external device) through the TB cable. Thereby, the CPU of the terminal device instructs the GPU of the display apparatus to generate an image signal, and the display apparatus can display an image based on the image signal which is generated in the GPU of itself.

In the above-described display system (in display system which has terminal device and display apparatus having GPU), it is considered that the display system performs such a control as to display an image while using the GPU which has higher efficiency out of the GPU of the terminal device and the GPU of the display apparatus.

A method is disclosed in Japanese Patent Application Laid-Open No. 2009-188681, which compares rendering efficiency of a plurality of apparatuses, and uses an apparatus having higher rendering efficiency for rendering the image. In the method disclosed in Japanese Patent Application Laid-Open No. 2009-188681, GUI (Graphics User Interface) rendering efficiencies of a television and a camera are compared and an apparatus having higher GUI rendering efficiency is used for a rendering.

However, in order that the CPU of the PC controls the GPU built in the display apparatus, the PC needs to install a driver (driver software) of the GPU therein, and the CPU of the PC needs to read the driver and activate (execute) the driver. Specifically, in order that the CPU of the PC controls the GPU of the display apparatus, the PC needs the pre-processing which includes the installation of the driver, and the reading and the activation of the driver by the CPU of the PC.

For this reason, the disclosed method cannot display an image immediately after the terminal device is connected to the display apparatus, in a case where the GPU of the display apparatus is used for display, and has a problem that a user is to be wait for the display of the image until the above-described pre-processing is completed.

### SUMMARY OF THE INVENTION

According to an aspect of the present invention, at least one of the above-described drawbacks and disadvantages can be overcome.

According to another aspect of the present invention, a display apparatus which has a processor to be used for image processing can be appropriately controlled.

According to another aspect of the present invention, there is provided a terminal device comprising: a first image processing processor that generates a first image signal from image data; a connection unit configured to be connectable with a display apparatus, wherein the display apparatus includes a second image processing processor which generates a second image signal from the image data; and a control unit that controls the first image processing processor and the second image processing processor, wherein the control unit selects one of the first image processing processor and the second image processing processor, and wherein if the second image processing processor is selected, the control unit instructs the second image processing processor to perform a predetermined process, instructs the first image processing processor to generate the first image signal, and instructs the second image processing processor to generate the second image signal after the predetermined process is completed.

According to another aspect of the present invention, there is provided a display apparatus comprising: a connection unit configured to be connectable with a terminal device, wherein the terminal device includes a first image processing processor which generates a first image signal from image data; a second image processing processor that generates a second image signal from the image data, wherein the terminal device includes a control unit which controls the first image processing processor and the second image processing processor; and a display unit configured to display one of an image corresponding to the first image signal and an image corresponding to the second image signal, wherein if the second image processing processor is selected, the second image processing processor starts the execution of a predetermined process in accordance with the instruction from the control unit, and wherein after the predetermined process is completed, the second image processing processor starts the generation of the second image signal in accordance with the instruction from the control unit.

According to another aspect of the present invention, there is provided a method comprising: controlling a first image processing processor included in a terminal device and a second image processing processor included in a display apparatus, wherein the first image processing processor generates a first image signal from image data, and the second image processing processor generates a second image signal from the image data; selecting one of the first image processing processor and the second image processing processor; instructing the second image processing processor to perform a predetermined process if the second image processing processor is selected; instructing the first image processing processor to generate the first image signal if the second image processing processor is selected; and instructing the second image processing processor to generate the second image signal after the predetermined process is completed if the second image processing processor is selected.

Further features and aspects of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the present invention and, together with the description, serve to explain the principles of the present invention.

FIG. 1 is a view for describing one example of a display system according to Exemplary Embodiment 1.

FIG. 2 is a timing chart for describing one example of an operation of the display system according to Exemplary Embodiment 1.

FIG. 3 is a timing chart for describing one example of the operation of the display system according to Exemplary Embodiment 1.

FIG. 4 is a timing chart for describing one example of the operation of the display system according to Exemplary Embodiment 1.

FIG. 5 is a timing chart for describing one example of the operation of the display system according to Exemplary Embodiment 1.

FIG. 6 is a flow chart for describing one example of the operation of the display system according to Exemplary Embodiment 1.

FIG. 7 is a flow chart for describing one example of synchronization process according to Exemplary Embodiment 1.

FIG. 8 is a view for describing “adjustment of generated frame” according to Exemplary Embodiment 1.

FIG. 9 is a view for describing one example of a display system according to Exemplary Embodiment 2.

FIG. 10 is a flow chart for describing one example of an operation of the display system according to Exemplary Embodiment 2.

FIG. 11 is a flow chart for describing one example of the operation of the display system according to Exemplary Embodiment 2.

### DESCRIPTION OF THE EMBODIMENTS

Exemplary embodiments, features, and aspects of the present invention will be described below with reference to the drawings.

### Exemplary Embodiment 1

Exemplary Embodiment 1 will be described below.

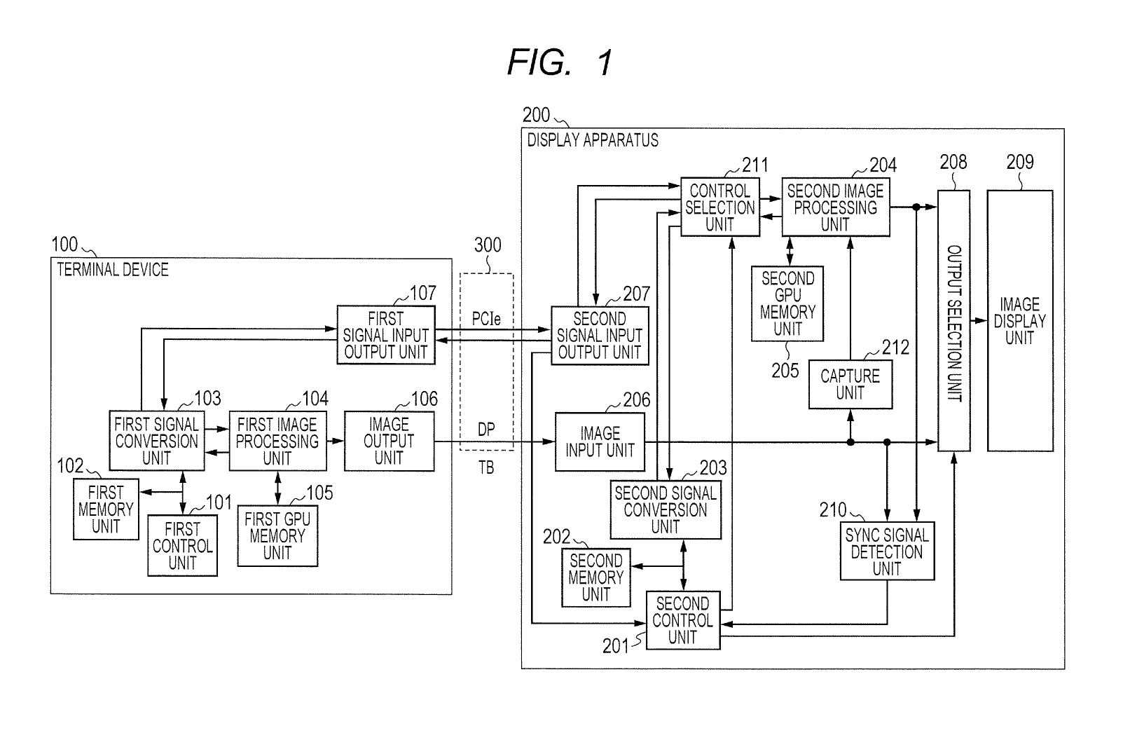

FIG. 1 is a view for describing one example of a display system according to Exemplary Embodiment 1. The display system according to Exemplary Embodiment 1 has a terminal device 100 and a display apparatus 200 which can be connected to each other. The terminal device 100 is connected with the display apparatus 200 by using one Thunderbolt cable (TB cable) 300. The terminal device is capable of acting as an external device or a source device.

The terminal device 100 is information machine or tools such as a PC (Personal Computer), a tablet computer or the like. The terminal device 100 can output a DP (DisplayPort) signal, and input and output a PCIe (Peripheral Component Interconnect Express) signal.

The display apparatus 200 has a GPU (Graphics Processing Unit) in its inner part. The display apparatus 200 can input a DP signal, and input and output a PCIe signal.

In Exemplary Embodiment 1, the DP signal is transmitted to the display apparatus 200 from the terminal device 100. In addition, the PCIe signal is transmitted between the terminal device 100 and the display apparatus 200. Incidentally, in FIG. 1, in order to simplify the content, a transmission line of the DP signal to be sent to the display apparatus 200 from the terminal device 100 is illustrated separately from a transmission line of the PCIe signal between the terminal device 100 and the display apparatus 200. However, transmission of the DP signal from the terminal device 100 to the display apparatus 200 and transmission of the PCIe signal between the terminal device 100 and the display apparatus 200 are both performed with the use of one TB cable 300. Specifically, both of the transmission of the DP signal to the display apparatus 200 from the terminal device 100 and the transmission of the PCIe signal between the terminal device 100 and the display apparatus 200 are enabled by the connection of the terminal device 100 to the display apparatus 200 with the use of the one TB cable 300.

The terminal device 100 will be described below.

A first control unit 101 is a CPU which controls each function unit of the terminal device 100. The first control unit 101 also controls a GPU (which corresponds to second image processing unit 204 that will be described later) of the display apparatus 200.

A first memory unit 102 is a work memory which the first control unit 101 uses.

A first signal conversion unit 103 converts a signal from the first control unit 101 into the PCIe signal. The first signal conversion unit 103 also converts the input PCIe signal into a signal capable of being processed by the first control unit 101, and outputs the converted signal to the first control unit 101.

A first image processing unit 104 is a GPU which performs a generating process for generating an image signal from image data. The first image processing unit 104 can operate as a first image processing processor. The first image processing unit 104 performs the generating process in accordance with the instruction from the first control unit 101. Specifically, the first control unit 101 outputs a signal including the image data and a command to the first image processing unit 104 through the first signal conversion unit 103. The first image processing unit 104 generates an image signal from the input image data, according to the input of the command.

A first GPU memory unit 105 is a graphics memory which the first image processing unit 104 uses.

An image output unit 106 converts the image signal which is generated in the first image processing unit 104 into the DP signal, and outputs the DP signal to the outside of the terminal device 100. In Exemplary Embodiment 1, the DP signal which is output from the terminal device 100 is input into the display apparatus 200 through the TB cable 300.

A first signal input output unit 107 outputs the PCIe signal to the outside from the inside of the terminal device 100, and inputs the PCIe signal to the inside from the outside of the terminal device 100. The first control unit 101 outputs the command to external machine or tools by using the first signal input output unit 107, and thereby can control the external machine or tools. In Exemplary Embodiment 1, the first control unit 101 outputs a signal (including image data and command) for making a second image processing unit 204 perform a generating process, to the display apparatus 200, with the use of the first signal input output unit 107. Thereby, the first control unit 101 can make the second image processing unit 204 perform the generating process. Incidentally, the signal for making the second image processing unit 204 perform the generating process is input into the display apparatus 200 through the TB cable 300.

The display apparatus 200 will be described below.

A second control unit 201 is a CPU which controls each function unit of the display apparatus 200.

A second memory unit 202 is a work memory which the second control unit 201 uses.

A second signal conversion unit 203 converts a signal sent from the second control unit 201 into a PCIe signal.

The second signal conversion unit 203 also converts the input PCIe signal into a signal capable of being processed by the second control unit 201, and outputs the converted signal to the second control unit 201.

A second image processing unit 204 is a GPU which performs a generating process for generating an image signal from image data. The second image processing unit 204 can operate as a second image processing processor. The second image processing unit 204 performs the generating process in accordance with the instruction from the second control unit 201. Specifically, the second control unit 201 outputs a signal including the image data and a command to the second image processing unit 204 through the second signal conversion unit 203. The second image processing unit 204 generates an image signal from the input image data according to the input of the command.

In addition, the second image processing unit 204 can also perform a generating process in accordance with the instruction from external machine or tools. In Exemplary Embodiment 1, the second image processing unit 204 performs a generating process in accordance with the instruction of the first control unit 101. Specifically, when the image data and the command which are output from the first control unit 101 are input into the second image processing unit 204, the second image processing unit 204 generates an image signal from the image data.

A second GPU memory unit 205 is a graphics memory which the second image processing unit 204 uses. In addition, the second GPU memory unit 205 also functions as a frame memory for holding image signals corresponding to a plurality of frames.

An image input unit 206 converts a DP signal which is input from the outside of the display apparatus 200 into an image signal. As described above, in Exemplary Embodiment 1, the DP signal which is output from the image output unit 106 is input into the image input unit 206 through the TB cable 300.

A second signal input output unit 207 outputs a PCIe signal to the outside from the inside of the display apparatus 200, and inputs a PCIe signal to the inside from the outside of the display apparatus 200. The second control unit 201 can respond to requests from the external machine or tools, with the use of the second signal input output unit 207. In Exemplary Embodiment 1, the second control unit 201 outputs a response signal which expresses a response to the request from the first control unit 101 to the terminal device 100, with the use of the second signal input output unit 207. Incidentally, the response signal is input into the terminal device 100 through the TB cable 300.

An output selection unit 208 switches an image to be displayed on an image display unit 209 between a first image signal which is an image signal obtained by the conversion of the DP signal that is input into the image input unit 206 and a second image signal which is an image signal that is generated in the second image processing unit 204. Specifically, the output selection unit 208 selects the first image signal or the second image signal, as an image signal to be displayed, in accordance with the instruction from the second control unit 201. Then, the output selection unit 208 outputs the selected image signal. The first image signal obtained by the conversion of the DP signal which is input into the image input unit 206 is an image signal that is generated in the first image processing unit 104.

The image display unit 209 displays an image based on the image signal which is selected in the output selection unit 208.

A sync signal detection unit 210 detects a synchronization signal of the first image signal and a synchronization signal of the second image signal, and informs the detected synchronization signals to the second control unit 201. The second control unit 201 performs synchronization process for synchronizing the first image signal and the second image signal with each other. The details of this process will be described later. In addition, after the first image signal and the second image signal synchronizes with each other, the second control unit 201 switches an output of the output selection unit 208 at the timing of the vertical synchronization signal (vertical synchronization signal of first image signal and second image signal), which is informed from the sync signal detection unit 210. Thereby, the display of the image display unit 209 can be switched in synchronization with the vertical synchronization signal.

For information, the synchronization process may be also performed by a function unit other than the second control unit 201. The synchronization process may be also performed, for instance, by a synchronization unit which the display apparatus 200 has.

A control selection unit 211 switches a transmission line of the PCIe signal in accordance with the instruction from the second control unit 201. In Exemplary Embodiment 1, the control selection unit 211 switches among three transmission lines. The first transmission line is a transmission line between the second image processing unit 204 and the second signal conversion unit 203. The connection of the second image processing unit 204 with the second signal conversion unit 203 enables a generating process according to the instruction from the second control unit 201 to be performed in the second image processing unit 204. The second transmission line is a transmission line between the second image processing unit 204 and the second signal input output unit 207. The connection of the second image processing unit 204 with the second signal input output unit 207 enables the PCIe signal which is input into the display apparatus 200 from the terminal device 100 to be transmitted to the second image processing unit 204. As a result, in the second image processing unit 204, a generating process according to the instruction from the first control unit 101 is enabled to be performed. The third transmission line is a transmission line between the second signal input output unit 207 and the second signal conversion unit 203. The connection of the second signal input output unit 207 with the second signal conversion unit 203 enables the PCIe signal which is input into the display apparatus 200 from the terminal device 100 to be converted into a signal capable of being processed by the second control unit 201, and enables the converted signal to be transmitted to the second control unit 201. The connection also enables the signal which is output from the second control unit 201 to be converted into the PCIe signal, and enables the PCIe signal to be output to the terminal device 100 from the display apparatus 200. As a result, the communication between the second control unit 201 and the first control unit 101 is enabled.

A capture unit 212 acquires the first image signal, and outputs the first image signal to the second image processing unit 204. The second image processing unit 204 can perform various kinds of image processing based on the first image signal which is output from the capture unit 212. The second image processing unit 204 can adjust, for instance, a frame of the second image signal to be generated, based on a frame number (temporal position in moving image) of the first image signal. The second image processing unit 204 can also perform image processing using the first image signal to the second image signal.

In Exemplary Embodiment 1, the first control unit 101 determines which of the first image processing unit 104 and the second image processing unit 204 is to be used, when the terminal device 100 is connected to the display apparatus 200. If the need of a user is considered, the image can be displayed which is based on an image signal that is generated in an image processing unit having higher efficiency between the first image processing unit 104 and the second image processing unit 204. Then, in Exemplary Embodiment 1, the first control unit 101 determines to use an image processing unit which has higher efficiency between the first image processing unit 104 and the second image processing unit 204.

However, in order that the first control unit 101 instructs the second image processing unit 204 to execute the generating process, the pre-processing is necessary which includes the installation and the activation of a driver (driver software) of the second image processing unit 204. Because of this, there is such a problem that a period of time required until the image is displayed results in being long, in a case where the second image processing unit 204 is used for the display.

Then, in Exemplary Embodiment 1, if the first control unit 101 determines to use the second image processing unit 204, the first control unit 101 performs the above-described pre-processing, and at the same time, instructs the first image processing unit 104 to generate an image signal from image data for display. After the above-described pre-processing is completed, the first control unit 101 instructs the second image processing unit 204 to generate an image signal from the above-described image data for display. Then, the output selection unit 208 makes the image display unit 209 display the image signal which is generated in the first image processing unit 104, at least until the image signal is generated in the second image processing unit 204. Specifically, the first control unit 101 controls the output selection unit 208 so as to select the image signal which is generated in the first image processing unit 104 at least until the image signal is generated in the second image processing unit 204. Thereby, the image can be displayed in a short period of time. After the image signal is generated in the second image processing unit 204, the output selection unit 208 also switches an image displayed on the image display unit 209 to an image based on the image signal which is generated in the second image processing unit 204, from an image based on the image signal which is generated in the first image processing unit 104.

Note that determining whether the efficiency of the second image processing unit 204 is higher than the efficiency of the first image processing unit 104 or not is performed by comparing, for instance, the information which indicates the efficiency of the second image processing unit 204, with the information which indicates the efficiency of the first image processing unit 104. The information which indicates the efficiency of the second image processing unit 204 may be previously stored in the terminal device 100, or may be input by a user. The information which indicates the efficiency of the first image processing unit 104 may be previously stored in the display apparatus 200, or may be input by a user.

For information, the image processing unit to be used may be determined also based on the type of the image data for display. It is acceptable, for instance, that in a case where the image data for display is still image data, the first image processing unit 104 is determined to be used, and that in a case where the image data for display is moving image data, the second image processing unit 204 is determined to be used. It is also acceptable that when the image data for display is image data for medical use, the first image processing unit 104 is determined to be used, and that in a case where the image data for display is illustration data, the second image processing unit 204 is determined to be used. In addition, it is acceptable that the image processing unit which is selected by the user is determined as the image processing unit to be used.

One example of an operation of a display system according to Exemplary Embodiment 1 will be described below.

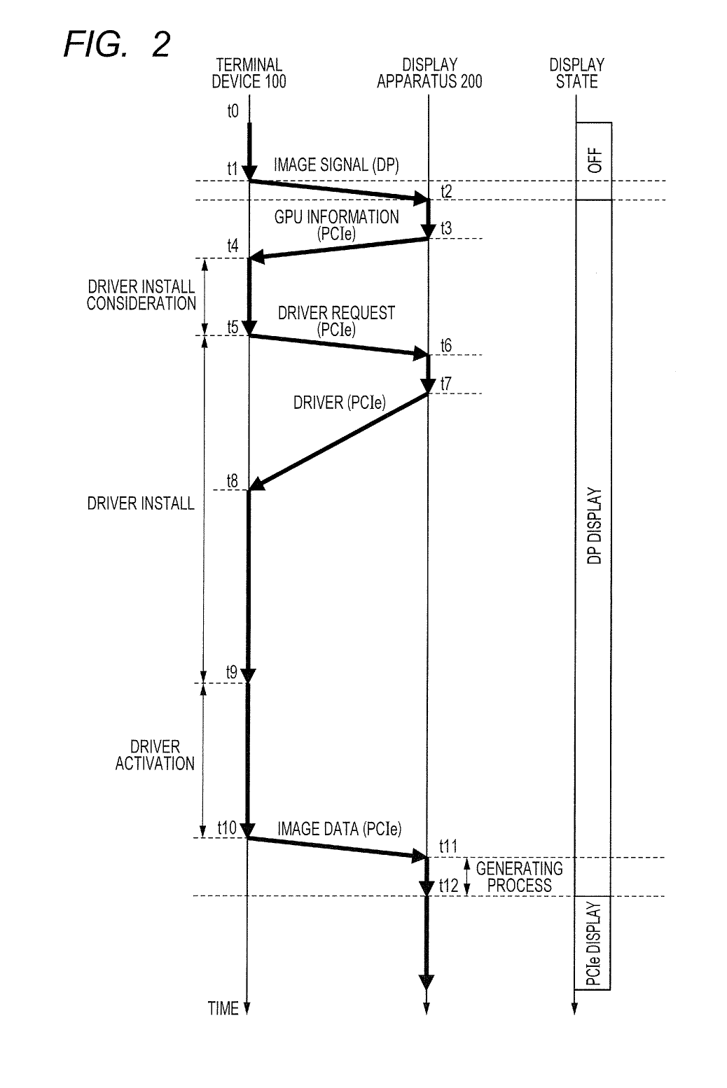

FIG. 2 is a timing chart for describing one example of the operation of the display system (which includes terminal device 100 and display apparatus 200), in a case where the terminal device 100 in such a state that the driver of the second image processing unit 204 is not installed therein and the DP signal is output is connected to the display apparatus 200. FIG. 2 illustrates the change of a display state of the image display unit 209. A display state “OFF” means such a state that the image is not displayed (or such state that DP signal is not input into display apparatus 200 from external machine or tools). A display state “DP display” means such a state that an image based on the DP signal (specifically, first image signal) is displayed, which is output from the terminal device 100. A display state “PCIe display” means such a state that an image based on the second image signal which is generated in the second image processing unit 204 in accordance with the instruction sent from the control unit 101, is displayed.

At the time t0, the terminal device 100 is not connected to the display apparatus 200, and accordingly the display state is in the state of “OFF”.

At the time t1, the terminal device 100 is connected with the display apparatus 200 by using the TB cable 300. At this time, the DP signal is output from the image output unit 106. This DP signal is input into the image input unit 206 through the TB cable 300, and is converted into the first image signal.

At the time t2, the display state is switched to “DP display”. Specifically, at the time t2, the sync signal detection unit 210 detects a synchronization signal of the first image signal which is obtained by the conversion of the DP signal, and informs the result to the second control unit 201. Then, the second control unit 201 controls the output selection unit 208 so as to select the first image signal, in synchronization with a vertical synchronization signal of the first image signal. Thereby, the image display unit 209 displays an image based on the first image signal obtained by the conversion of the DP signal.

At the time t3, the second control unit 201 is connected to the second signal input output unit 207 through the control selection unit 211, and attempts to be connected to the first control unit 101 of the terminal device 100 through the TB cable 300.

At the time t4, the PCIe connection is established between the second control unit 201 and the first control unit 101, and the information of the GPU (second image processing unit 204) which the display apparatus 200 has is informed to the first control unit 101. The first control unit 101 considers whether to install a driver for directly controlling the second image processing unit 204, based on the above-described information of the GPU.

Here, one example of a method of considering whether to install the driver is given.

A process for generating a simple graphic (rectangular image or the like) of a VGA (Video Graphics Array) size is previously executed in the first image processing unit 104. The number of the graphics which can be generated for one second is counted, and is stored in the first memory unit. The first control unit 101 transmits a command (PCIe signal) for making the second image processing unit 204 execute the same process as the above-described process (repetition of generation of graphics), to the second control unit 201 through the TB cable 300. Then, the second control unit 201 makes the second image processing unit 204 execute the same process as the above-described process, by using the above-described command. The second image processing unit 204 counts the number of the graphics which are capable of being generated for one second, and informs the counted number to the second control unit 201. The second control unit 201 informs the count number (number of graphics) which is informed from the second image processing unit 204, to the first control unit 101. The first control unit 101 compares the count numbers of the second image processing unit 204 and the first image processing unit 104. If the display apparatus 200 can generate more graphics than the terminal device 100 for one second, the first control unit 101 determines that the efficiency of the second image processing unit 204 is higher than the efficiency of the first image processing unit 104. Then, the first control unit 101 determines to install the driver of the second image processing unit 204 in the terminal device 100.

Note that the method of determining whether the efficiency of the second image processing unit 204 is higher than the efficiency of the first image processing unit 104 or not (whether to install driver) is not limited to the above-described method. For instance, it is acceptable that each apparatus previously executes a benchmark software for determining the efficiency of the GPU, and converts the execution result (score) for the software into the form of a database. In this case, at the time t4, the first control unit 101 may refer to a score corresponding to a model number of the GPU (second image processing unit 204) which is informed thereto, and a score corresponding to a model number of the first image processing unit 104, from the above-described database. It may be considered whether to install the driver based on the score of the second image processing unit 204 and the score of the first image processing unit 104. If the score is high as the efficiency is high, the first control unit 101 may determine to install the driver in a case where the score of the second image processing unit 204 is higher than the score of the first image processing unit 104. In addition, the above-described database is not necessarily held by the terminal device 100. As long as the terminal device 100 can be connected through the Internet, the above-described database may be acquired from the network.

When it is determined to install the driver of the second image processing unit 204 in the terminal device 100, at the time t5, the first control unit 101 transmits the PCIe signal for requesting the driver of the second image processing unit 204, to the second control unit 201 through the TB cable 300.

At the time t6, the second control unit 201 accepts the request (request for transmission of driver) from the first control unit 101.

At the time t7, the second control unit 201 starts the transmission of the driver to the first control unit 101. The driver (PCIe signal) is transmitted to the first control unit 101 from the second control unit 201 through the TB cable 300. Incidentally, here, the above-described operation is based on a premise that the display apparatus 200 holds the driver of the second image processing unit 204. However, if the display apparatus 200 or the terminal device 100 can access the Internet, the apparatus can acquire the driver through the network, and accordingly the display apparatus 200 does not necessarily need to hold the driver. In addition, in a case where the terminal device 100 can access the Internet, the terminal device 100 may directly acquire the driver through the network without using the display apparatus 200.

At the time t8, obtaining the driver of the second image processing unit 204 by the first control unit 101 is completed. Then, the first control unit 101 starts the installation of the driver.

At the time t9, the installation of the driver of the second image processing unit 204 is completed, and the first control unit 101 activates the driver.

At the time t10, the second control unit 201 controls the control selection unit 211, and connects the second signal input output unit 207 with the second image processing unit 204. Thereby, the second image processing unit 204 can be directly controlled from the first control unit 101 of the terminal device 100. When the activation of the driver is completed and the connection of the first control unit 101 with the second image processing unit 204 is established, the first control unit 101 starts transmitting an instruction (including image data and command) to execute the generating process, directly to the second image processing unit 204 through the TB cable 300. Here, the image data is the same image data (image data for display) as the image data which is used for the generation of the DP signal.

At the time t11, the generating process by the second image processing unit 204 starts. In addition, the second control unit 201 performs synchronization process at this timing. The synchronization process includes “adjustment of generated frame” and “synchronization of Vsync”. “Adjustment of generated frame” is a process for making a frame (time position in moving image) of the second image signal which is the image signal generated in the second image processing unit correspond to a frame of the first image signal which is the image signal generated in the first image processing unit. “Synchronization of Vsync” is a process for synchronizing the vertical synchronization signal of the second image signal with the vertical synchronization signal of the first image signal. Specifically, in “adjustment of generated frame”, the second image signal is compared to the first image signal which is generated from the DP signal. Then, frames generated by the respective GPUs are adjusted so that the first image signal and the second image signal of the same frame can be input into the output selection unit 208, based on the comparison result. In “synchronization of Vsync”, the sync signal detection unit 210 detects synchronization signals of the first image signal and the second image signal, and informs the synchronization signals to the second control unit 201. The second control unit 201 performs a process for synchronizing the vertical synchronization signals of the image signals based on the informed synchronization signals. The detailed description of the synchronization process will be described later.

At the time t12, the sync signal detection unit 210 informs the vertical synchronization signal which the second image processing unit 204 outputs, to the second control unit 201. The second control unit 201 controls the output selection unit 208 so that the display is switched to the image based on the second image signal from the image based on the first image signal, at this timing of the vertical synchronization signal. From the time t12 on down, in the image display unit 209, the image based on the second image signal is displayed which is generated in the second image processing unit 204.

Incidentally, the above-described operation is an example of the case where the first control unit 101 directly controls the second image processing unit 204 (case where it is determined to install driver in terminal device 100). In the case where the first control unit 101 does not directly control the second image processing unit 204 (for instance, case where it is determined not to install driver in the terminal device 100), the above-described process after the time t4 (process from time t5 to t12) is not performed, and the display state “DP display” is maintained.

Note that after the display state is switched to “PCIe display” from “DP display”, the generating process by the first image processing unit 104 may be continuously executed, or may be stopped.

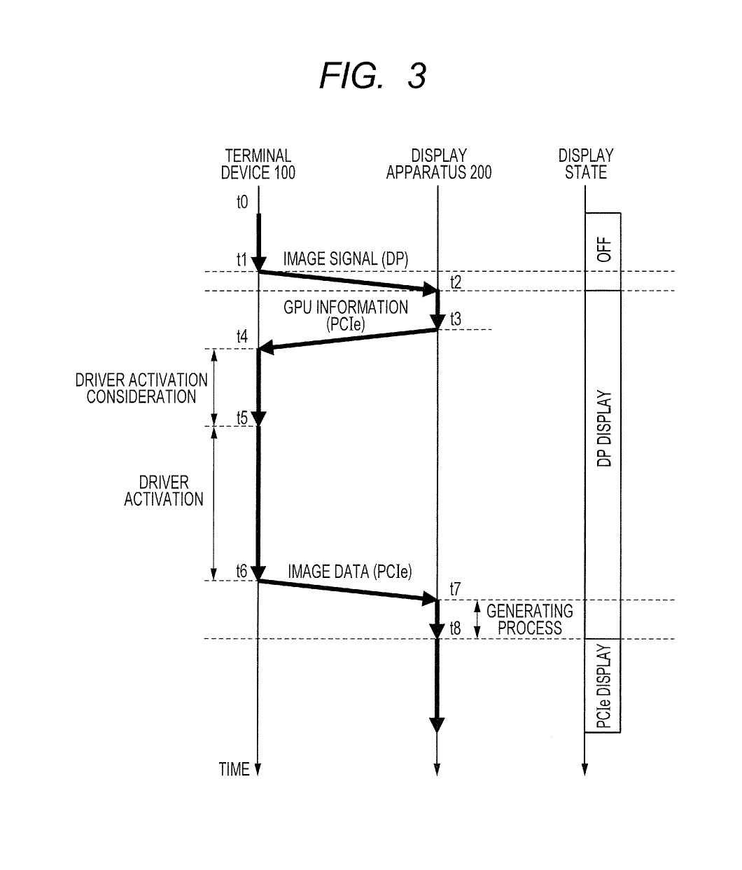

FIG. 3 is a timing chart for describing one example of an operation of the display system, in a case where the terminal device 100 in such a state that the driver of the second image processing unit 204 is installed therein and a DP signal is output is connected to the display apparatus 200. Incidentally, each time in the following description means the time described in FIG. 3, unless otherwise specifically mentioned.

The process from the time t0 to t3 is the same process as process from the time t0 to t3 in FIG. 2, and accordingly the description will be omitted.

At the time t4, the PCIe connection is established between the second control unit 201 and the first control unit 101, and the information of the GPU (second image processing unit 204) which the display apparatus 200 has is informed to the first control unit 101. The first control unit 101 determines that a driver for directly controlling the second image processing unit 204 is already installed, based on the above-described information of the GPU. Then, the first control unit 101 considers whether to activate the driver of the second image processing unit 204, based on the above-described information of the GPU. Incidentally, a method of determining whether to activate the driver is the same method as the determination method (method of determining whether to install driver) which is described with reference to FIG. 2, and accordingly the description will be omitted.

If it is determined to activate the driver of the second image processing unit 204, the first control unit 101 activates the driver of the second image processing unit 204, at the time t5.

The process from the time t6, the time t7 and the time t8 is the same process as process from the time t10, the time t11 and the time t12 in FIG. 2, respectively, and accordingly the description will be omitted.

Incidentally, the above-described operation is an example of the case where the first control unit 101 directly controls the second image processing unit 204 (case where it is determined to activate driver of second image processing unit 204). In the case where the first control unit 101 does not directly control the second image processing unit 204 (for instance, case where it is determined not to activate driver of second image processing unit 204), the above-described process after the time t4 (process from time t5 to t8) is not performed, and the display state “DP display” is maintained.

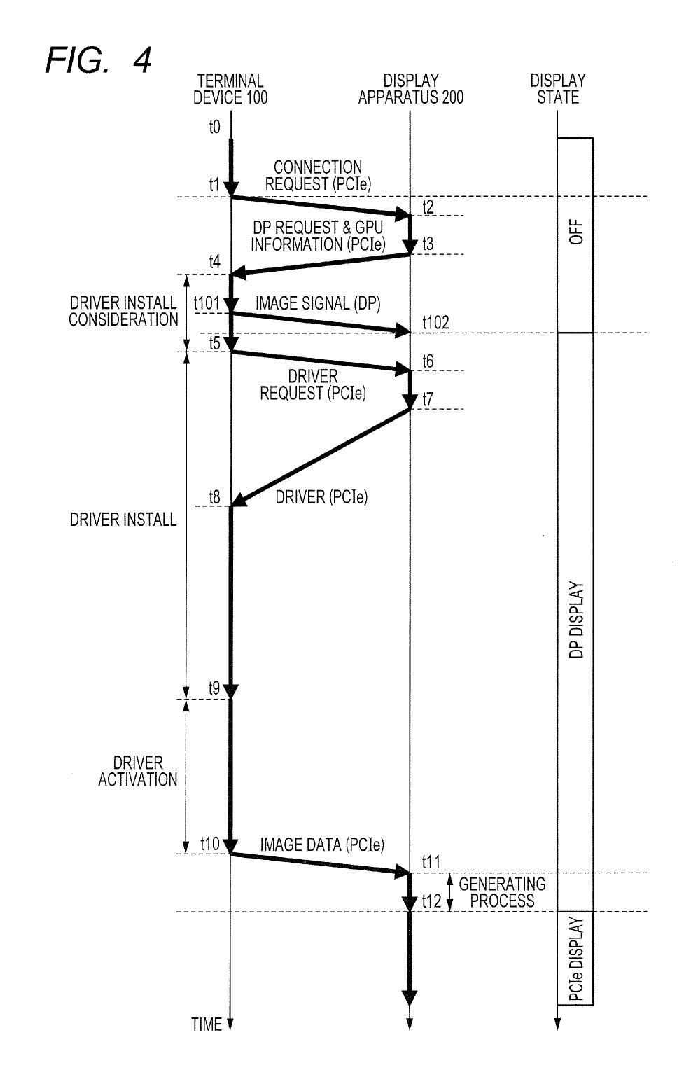

FIG. 4 is a timing chart for describing one example of an operation of the display system, in a case where the terminal device 100 in such a state that the driver of the image processing unit 204 is not installed therein and a DP signal is output is connected to the display apparatus 200. Incidentally, each time in the following description means the time described in FIG. 4, unless otherwise specifically mentioned.

At the time t1, the terminal device 100 is connected with the display apparatus 200 by using the TB cable 300. Then, the first control unit 101 attempts the connection (PCIe connection) of itself to the second control unit 201 of the display apparatus 200 through the first signal input output unit 107 and the TB cable 300.

At the time t2, the second signal input output unit 207 detects a PCIe connection request (PCIe signal) from the outside, and informs the request to the second control unit 201. The second control unit 201 controls the control selection unit 211 so that the second signal input output unit 207 and the second signal conversion unit 203 are connected to each other, according to the information. Thereby, the PCIe connection of the second control unit 201 with the first control unit 101 is established.

At the time t3, the second control unit 201 transmits the PCIe signal for requesting the output of the DP signal, to the first control unit 101 through the TB cable 300. The second control unit 201 also transmits the PCIe signal that is the information of the GPU (second image processing unit 204) which the display apparatus 200 has, to the first control unit 101 through the TB cable 300.

At the time t4, the first control unit 101 accepts a DP output request (request for output of DP signal) from the second control unit 201. The first control unit 101 transmits an instruction (including image data for display and command) to execute a generating process, to the first image processing unit 104, according to the DP output request. Thereby, the first image processing unit 104 performs a process for generating the first image signal from image data for display. In addition, at the time t4, the information of the second image processing unit 204 is informed to the first control unit 101. Then, the first control unit 101 considers whether to install a driver for directly controlling the second image processing unit 204, based on the above-described information of the second image processing unit 204. A method of determining whether to install the driver is the same method as the determination method described with reference to FIG. 2, and accordingly the description will be omitted.

At the time t101, the DP signal (DP signal obtained by conversion of first image signal generated from image data for display) is output from the image output unit 106. Then, this DP signal is input into the image input unit 206 through the TB cable 300, and is converted into the first image signal.

At the time t102, the sync signal detection unit 210 detects a synchronization signal of the above-described first image signal obtained by the conversion of the DP signal, and informs the result to the second control unit 201. The second control unit 201 controls the output selection unit 208 so that the display of an image based on the first image signal starts at the timing of the vertical synchronization signal of the above-described first image signal. From the time t102 on down, in the image display unit 209, the image based on the first image signal is displayed which is generated in the first image processing unit 104. Incidentally, before the time t102, the display state of the image display unit 209 is in the state of “OFF”.

If it is determined to install the driver of the second image processing unit 204 in the terminal device 100, the process from the time t5 to the time t12 is performed. The process from the time t5 to the time t12 is the same process as process from the time t5 to t12 in FIGS. 2, and accordingly the description will be omitted.

Incidentally, the above-described operation is an example of the case where the first control unit 101 directly controls the second image processing unit 204 (case where it is determined to install driver in terminal device 100). In the case where the first control unit 101 does not directly control the second image processing unit 204 (for instance, case where it is determined not to install driver in terminal device 100), the above-described process from the time t5 to t12 is not performed, and the display state “DP display” is maintained from the time t102.

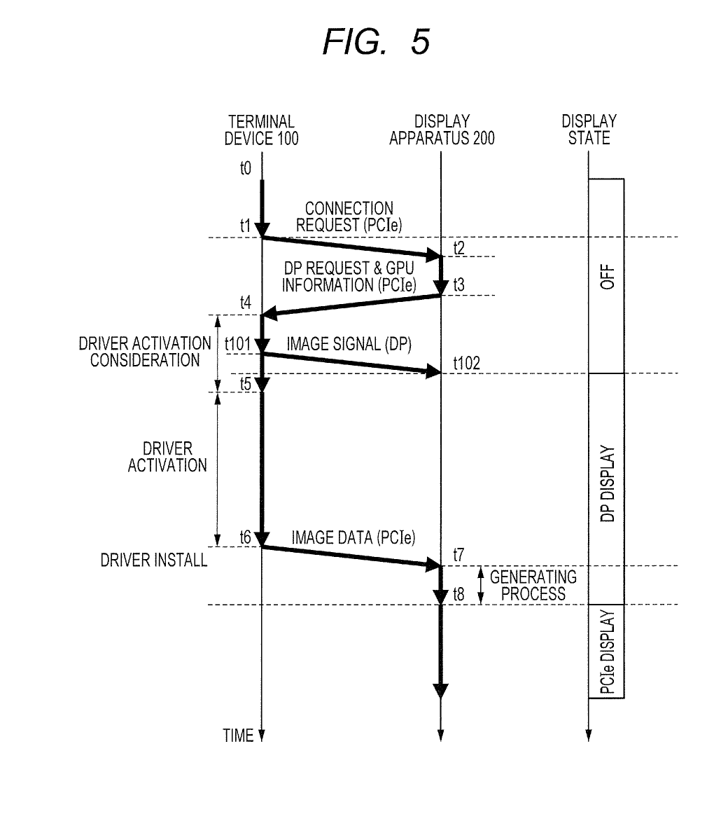

FIG. 5 is a timing chart for describing one example of an operation of the display system, in a case where the terminal device 100 in such a state that the driver of the second image processing unit 204 is installed therein and a DP signal is output is connected to the display apparatus 200. Incidentally, each time in the following description means the time described in FIG. 5, unless otherwise specifically notified.

The process from the time t0 to t3 is the same process as process from the time t0 to t3 in FIG. 4, and accordingly the description will be omitted.

At the time t4, the first control unit 101 accepts a DP output request (request for output of DP signal) from the second control unit 201. The first control unit 101 transmits an instruction (including image data for display and command) to execute a generating process, to the first image processing unit 104, according to the DP output request. Thereby, the first image processing unit 104 performs a process for generating the first image signal from image data for display. In addition, at the time t4, the information of the second image processing unit 204 is informed to the first control unit 101. The first control unit 101 determines that a driver for directly controlling the second image processing unit 204 is already installed, based on the above-described information of the second image processing unit 204. Then, the first control unit 101 considers whether to activate the driver of the second image processing unit 204, based on the above-described information of the second image processing unit 204. A method of determining whether to activate the driver is the same method as the determination method (method of determining whether to install driver) which is described with reference to FIG. 2, and accordingly the description will be omitted.

The process from the time t101 and the time t102 is the same process as process from the time t101 and the time t102 in FIG. 4, respectively, and accordingly the description will be omitted.

If it is determined to activate the driver of the second image processing unit 204, the first control unit activates the driver of the second image processing unit 204, at the time t5.

The process from the time t6, the time t7 and the time t8 is the same process as process from the time t10, the time t11 and the time t12 in FIG. 4, respectively, and accordingly the description will be omitted.

Incidentally, the above-described operation is an example of the case where the first control unit 101 directly controls the second image processing unit 204 (case where it is determined to activate driver of second image processing unit 204). In the case where the first control unit 101 does not directly control the second image processing unit 204 (for instance, case where it is determined not to activate driver of second image processing unit 204), the above-described process from the time t5 to t8 is not performed, and the display state “DP display” is maintained from the time t102.

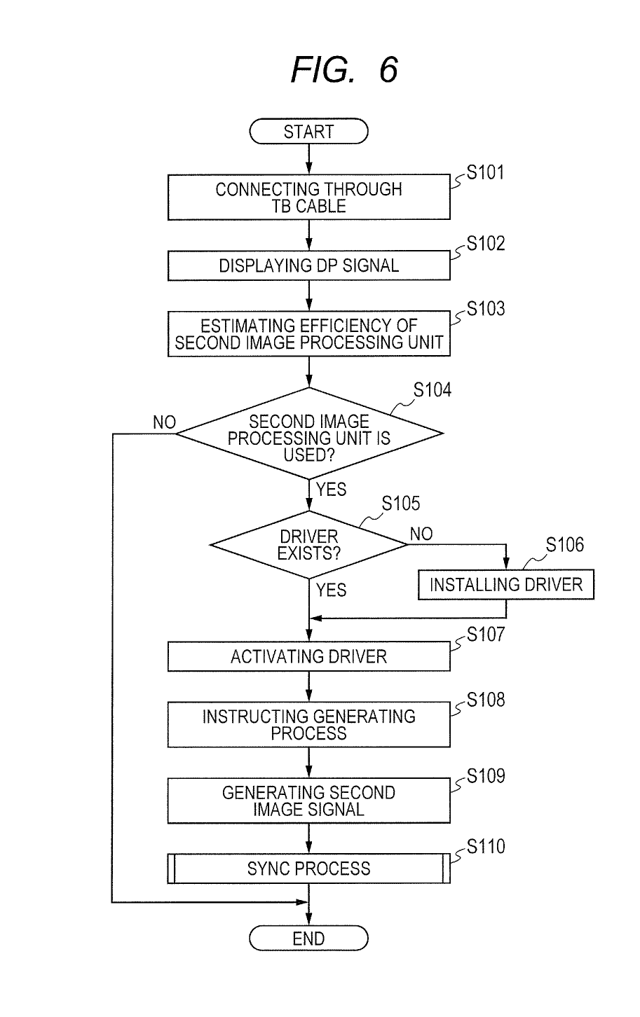

FIG. 6 is a flow chart for describing one example of an operation of the display system in a case where when the terminal device 100 is connected to the display apparatus 200.

Firstly, in S101, the terminal device 100 is connected to the display apparatus 200 by using the TB cable 300. In the example of FIG. 2, the process of S101 is performed at the time t1.

Next, in S102, the terminal device 100 outputs the DP signal, and the display apparatus 200 displays an image based on the input DP signal, on the image display unit 209. In the example of FIG. 2, the display of the image is started by the process of S102, at the time t2.

Then, in S103, the terminal device 100 estimates the efficiency of the GPU (second image processing unit 204) which the display apparatus 200 has. In the example of FIG. 2, the process of S103 is started at the time t4.

Next, in S104, the terminal device 100 determines whether to directly control the GPU (second image processing unit 204) which the display apparatus 200 has, or not. In Exemplary Embodiment 1, in a case where the efficiency of the first image processing unit 104 is higher than the efficiency of the second image processing unit 204, the terminal device 100 determines that the terminal device 100 does not (directly) control the second image processing unit 204. Then, the present processing flow is ended (display state “DP display” is maintained). If the efficiency of the second image processing unit 204 is higher than the efficiency of the first image processing unit 104, the process progresses to S105. In the example of FIG. 2, the process of S104 is completed at the time t5, and the process progresses to S105.

In S105, the first control unit 101 determines whether the driver of the second image processing unit 204 is installed in the terminal device 100, or not. If the driver of the second image processing unit 204 is installed in the terminal device 100, the process progresses to S106. If the driver of the second image processing unit 204 is not installed in the terminal device 100, the process progresses to S107. In the example of FIG. 2, the process of S105 is started at the time t5, and the process progresses to S106. In the example of FIG. 3, the process of S105 is started at the time t5, and the process progresses to S107.

In S106, the first control unit 101 performs a process for installing the driver of the second image processing unit 204 in the terminal device 100. Then, the process progresses to S107. In the example of FIG. 2, the process of S106 is performed in a period from the time t5 to the time t9.

In S107, the first control unit 101 performs a process for activating the installed driver of the second image processing unit 204 in the terminal device 100. In the example of FIG. 2, the process of S107 is performed in a period from the time t9 to the time t10.

Subsequently to S107, in S108, an instruction (including image data and command) to execute a generating process is transmitted to the second image processing unit 204 from the first control unit 101. Specifically, a PCIe signal which expresses the instruction to execute the generating process is transmitted to the second image processing unit 204 from the first control unit 101 through the TB cable 300. In the example of FIG. 2, the process of S108 is started at the time t10.

Then, in S109, the second image processing unit 204 starts the generating process in accordance with the instruction from the first control unit 101. In the example of FIG. 2, the process of S109 is started at the time t11.

Next, in S110, the second control unit 201 performs synchronization process. After that, the second control unit 201 controls the output selection unit 208, and thereby the second image signal which is generated in the second image processing unit 204 is transmitted to the image display unit 209. Thereby, the display is switched to an image based on the second image signal from an image based on the first image signal. In the example of FIG. 2, the process of S110 is performed in a period from the time t11 to the time t12.

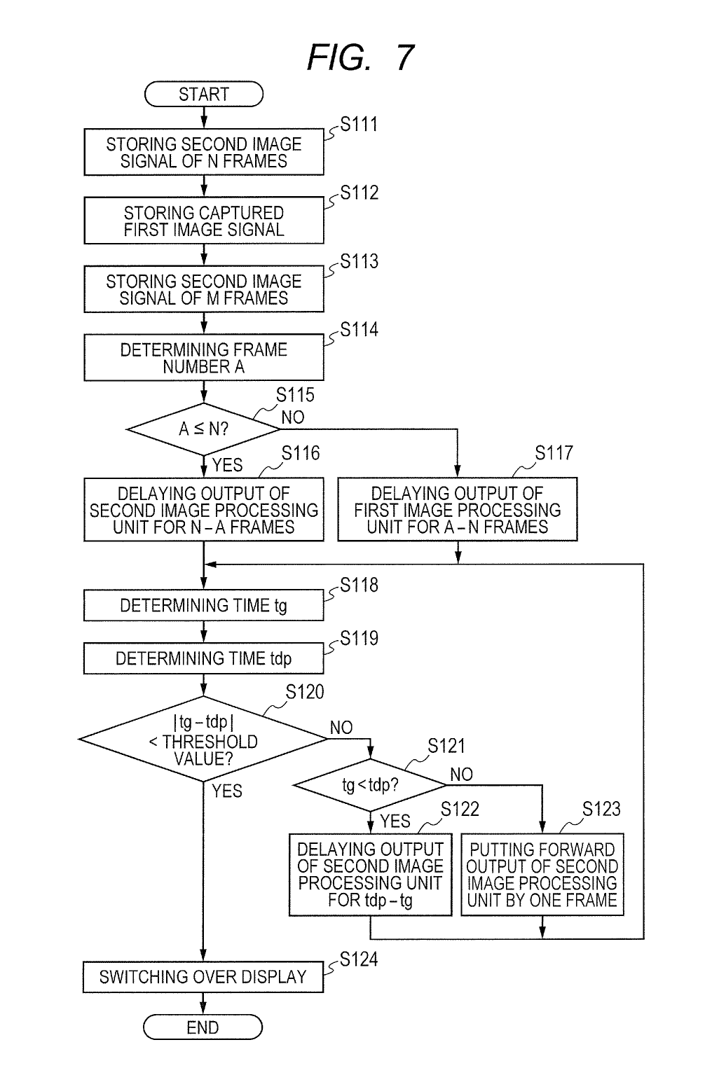

The details of the synchronization process of S110 will be described below with reference to a flow chart of FIG. 7. As described above, the synchronization process includes “adjustment of generated frame” and “synchronization of Vsync”. In addition, in S110, “output switching in synchronization with Vsync” is also performed.

(1) “Adjustment of Generated Frame”

“Adjustment of generated frame” is an adjustment process for inputting a second image signal and a first image signal of the same frame, into an output selection unit 208. By the alignment of the frame of the second image signal with the frame of the first image signal, it can be prevented that the frame of an image to be displayed skips when the output of the output selection unit 208 is switched.

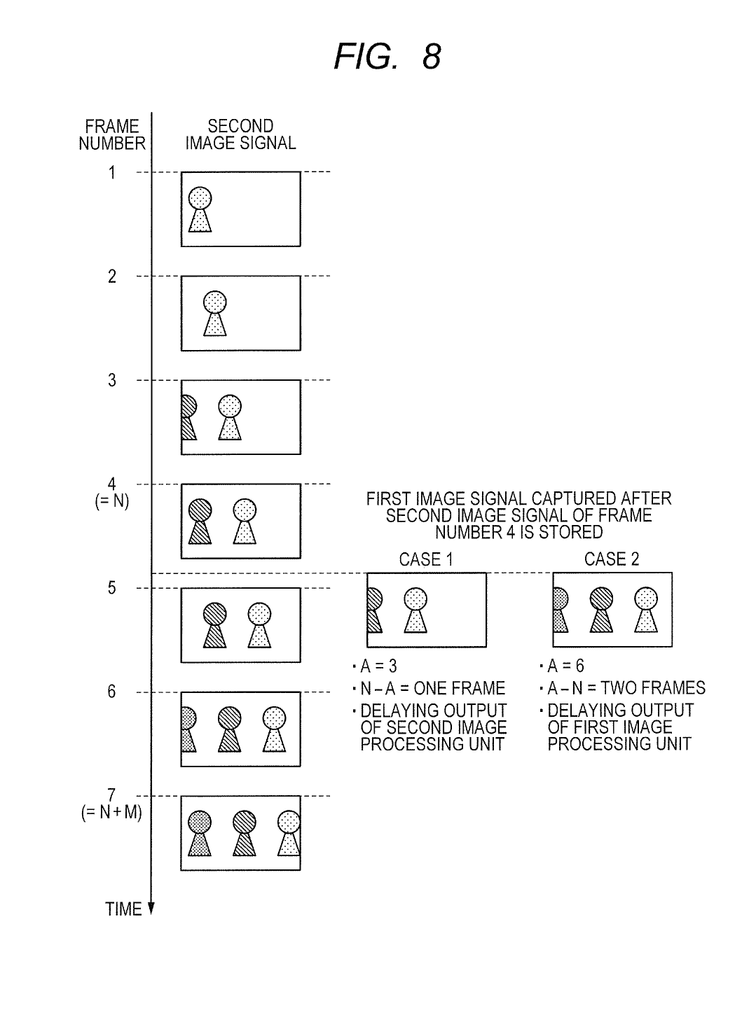

FIG. 8 is an explanatory drawing for describing “adjustment of generated frame”.

One example of “adjustment of generated frame” will be described below with reference to FIGS. 7 and 8.

Firstly, in S111, the second image processing unit 204 stores a second image signal of N frames which are generated in accordance with the instruction from the first control unit 101, in a second GPU memory unit 205. FIG. 8 illustrates an example of N=4.

Next, in S112, a capture unit 212 acquires the first image signal, and outputs the first image signal to the second image processing unit 204. The second image processing unit 204 stores the captured first image signal in the second GPU memory unit 205. FIG. 8 illustrates two cases (Case 1 and Case 2) where the captured first image signals are different from each other.

Then, in S113, the second image processing unit 204 stores a second image signal of M frames which are generated in accordance with the instruction from the first control unit 101, in the second GPU memory unit 205. Here, the second image signal of the N+M frames and the captured first image signal are stored in the second GPU memory unit 205. FIG. 8 illustrates an example of M=3.

Next, in S114, the second image processing unit 204 determines correlation between the captured first image signal and the second image signals of the N+M frames. Then, the second image processing unit 204 selects the frame which has the highest correlation with the captured first image signal, from the above-described N+M frames. In Exemplary Embodiment 1, numbers (frame numbers) from 1 to N+M are sequentially assigned to the above-described N+M frames. Then, a number A of the frame is determined which has the highest correlation with the captured first image signal. In the example of FIG. 8, it is shown that in the case of Case 1, A=3, and in the case of Case 2, A=6.

The degree of the correlation between the two frames (two images) can be determined, for instance, from a sum of an absolute difference between respective pixels of the two images. Specifically, it can be determined that the correlation is higher as the above-described total sum is smaller. Because of this, assuming that P0 (x, y) represents a pixel value in a coordinate (x, y) of the captured first image signal and P (x, y) represents a pixel value in a coordinate (x, y) of the second image signal, the frame number of the second image signal which minimizes the value obtained by the following Expression 1 is to be A.

Σ_{x,y}|P0(x,y)−P(x,y)|

Note that in a case where resolutions (image sizes) of the first image signal and the second image signal are different from each other, a scaling process (enlargement process or reduction process) is performed which equalizes the resolutions of the first image signal and the second image signal to each other, and thereby the above-described calculation is enabled. Incidentally, the scaling process may be applied to the first image signal, or may be applied to the second image signal.

Subsequently to S114, in S115, the second image processing unit 204 determines whether A is N or smaller, or not. If A is less than or equal to N, the process progresses to S116. If A is larger than N, the process progresses to S117. In the example of FIG. 8, in the case of Case 1, it is determined that A is less than or equal to N, and the process progresses to S116. In the case of Case 2, it is determined that A is larger than N, and the process progresses to S117.

In S116, the output of the second image processing unit 204 is delayed for N—A frames. The output of the second image processing unit 204 is delayed with the use of the second GPU memory unit 205. In the example of FIG. 8, in the case of Case 1, A=3 and N=4, and accordingly the output of the second image processing unit 204 is delayed for one frame, with the use of the second GPU memory unit 205. Thereby, the frame of the second image signal corresponds to the frame of the first image signal.

In S117, the output of the first image processing unit 104 is delayed for A-N frames. The output of the first image processing unit 104 is delayed with the use of the first GPU memory unit 105. In the example of FIG. 8, in the case of Case 2, A=6 and N=4, and accordingly the output of the first image processing unit 104 is delayed for two frames, with the use of the first GPU memory unit 105. Thereby, the frame of the second image signal corresponds to the frame of the first image signal.

The delay of the frame is achieved, for instance, by such process that the second control unit 201 obtains a difference between A and N, and the second control unit 201 controls the second image processing unit 204 or the second control unit 201 sends instruction to the first control unit 101 so as to control the first image processing unit 104.

For information, the correlation may be determined also by the second control unit 201.

By the above process, “adjustment of generated frame” is completed.

Subsequently to S116 or S117, the process progresses to S118.

(2) “Synchronization of Vsync”

In S118, the sync signal detection unit 210 detects Vsync (vertical synchronization signal) of the second image signal which is generated in the second image processing unit 204, and determines the time of occurrence tg.

Next, in S119, the sync signal detection unit 210 detects Vsync of the first image signal which is obtained in the image input unit 206, and determines the time of occurrence tdp. The time of occurrence tg and the time of occurrence tdp are the times of occurrence of Vsync of the second image signal and the first image signal of the same frame.

Incidentally, the sync signal detection unit 210 shall independently determine each of the time tg and the time tdp. For this reason, the process of S118 may be performed after the process of S119.

In S120, the values of the time tg and the time tdp are transmitted to the second control unit 201. The second control unit 201 controls the second image processing unit 204 based on those values (values of time tg and time tdp), and synchronizes the second image signal with the first image signal.

For instance, an absolute difference between the time tg and the time tdp is calculated, and it is determined whether this absolute value is smaller than a predetermined threshold value (threshold value set by manufacturer or user) or not. If the absolute value is smaller than the predetermined threshold value, it is determined that the first image signal and the second image signal synchronize with each other, and the process progresses to S124. If the absolute value is the predetermined threshold value or larger, it is determined that the first image signal and the second image signal do not synchronize with each other, and the process progresses to S121.

Incidentally, the above-described predetermined threshold value can be a value smaller than a length of a front porch period of the vertical synchronization signal of the first image signal. If the above-described predetermined threshold value is set at the value smaller than the length of the front porch period of the vertical synchronization signal of the first image signal, the display of the image display unit 209 can be prevented from being disturbed when being changed over. In other words, the output selection unit 208 can switch the output signal from the first image signal to the second image signal, in a blank period of the first image signal.

In S121, the second control unit 201 determines which of the time tg and the time tdp precedes.

If tg<tdp holds (in a case where time tg precedes time tdp), it can be understood that the synchronization signal of the second image signal precedes that of the first image signal (synchronization signal of first image signal is later than that of second image signal). In this case, the process progresses to S122. In S122, the second control unit 201 controls the second image processing unit 204 so that the synchronization signal of the second image signal is delayed for a period of time (tdp−tg).

If tg<tdp does not hold (in a case where time tg is later than time tdp), it can be understood that the synchronization signal of the second image signal is later than that of the first image signal (synchronization signal of first image signal precedes that of second image signal). In this case, the process progresses to S123. In S123, the second control unit 201 controls the second image processing unit 204 so that the frame of the second image signal to be generated becomes a frame preceding by one frame (so that one frame to be generated is omitted). Thereby, the synchronization signal of the second image signal results in passing the synchronization signal of the first image signal.

After the process of S121 and the process of S122 or S123 subsequent to S121 are executed, the process from S118 on is performed again. In a case where it is determined in S120 that the first image signal and the second image signal synchronize with each other, the process progresses to S124.

(3) “Output Switching in Synchronization with Vsync”

In S124, the second control unit 201 controls the output selection unit 208 at such a timing that the sync signal detection unit 210 detects Vsync from the second image processing unit 204. Thereby, the display of the image display unit 209 is switched to an image based on the second image signal from an image based on the first image signal, in synchronization with Vsync of the second image signal (Vsync in synchronization with Vsync of first image signal).

As described above, the display system according to Exemplary Embodiment 1 can display an image in a shorter period of time after the terminal device is connected with the display apparatus, in a case where an image processing processor of the display apparatus is used for the display.

Note that in Exemplary Embodiment 1, the example is illustrated in which the terminal device is connected with the display apparatus by using one cable, but the example is not limited to this example. The PCIe signal and the DP signal may be transmitted with the use of different cables from each other.

Also note that the synchronization process may not be performed. Even in a case where the display system is configured in such a way, the above-described effect can be obtained. If the synchronization process is performed and an image is switched in synchronization with the vertical synchronization signal of the second image signal, it can be suppressed that the display is disturbed when the image is switched.

### Exemplary Embodiment 2

Exemplary Embodiment 2 will be described below. Incidentally, functions different from those in Exemplary Embodiment 1 will be described in detail below, and the description on the same functions as those in Exemplary Embodiment 1 will be omitted.

In Exemplary Embodiment 1, the example is described in which the display of the image display unit 209 is switched to the image based on the second image signal from the image based on the first image signal.

In Exemplary Embodiment 2, an example will be described below in which image processing is performed so that the display is not suddenly changed when the display is switched.

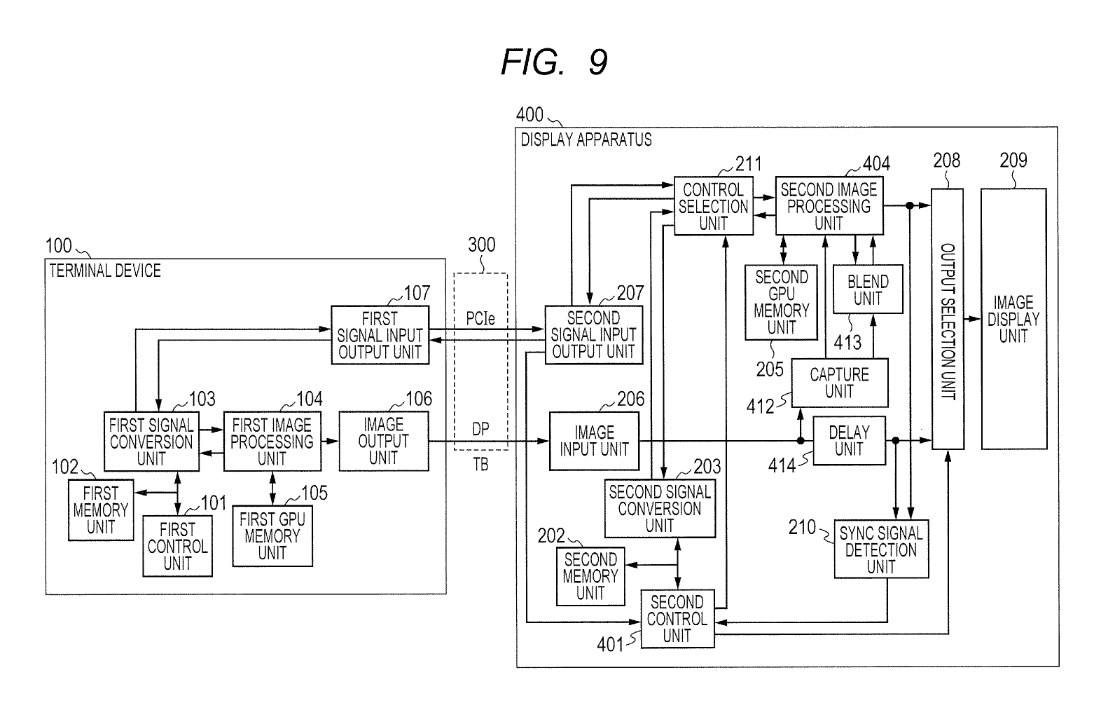

FIG. 9 is a view for describing one example of a display system according to Exemplary Embodiment 2. The same functions as those in Exemplary Embodiment 1 will be designated by the same reference numerals, and the description will be omitted.

A second control unit 401 has a function of informing at least one part of processing parameters to be used when a second image processing unit 404 generates an image signal, to the terminal device 100, in addition to the function of the second control unit 201 in Exemplary Embodiment 1. Specifically, the second control unit 401 transmits a PCIe signal which expresses the processing parameter to the terminal device 100 through the TB cable 300. The processing parameter is a parameter of determining at least any one of luminance characteristics and chrominance characteristics of the second image signal. For instance, the processing parameter is information which expresses a color space, a γ value and the like of the second image signal.

Incidentally, in Exemplary Embodiment 2, the processing parameter is to be obtained by the first control unit 101, but may be obtained by a function unit other than the first control unit 101. For instance, the processing parameter may be obtained by an acquisition unit which the terminal device 100 has. In addition, the terminal device 100 may not obtain the processing parameter from a display apparatus 400, but a user may input the processing parameter into the terminal device 100.

The second image processing unit 404 has a function of operating as the second image processing unit 204 in Exemplary Embodiment 1, and has a function of outputting the generated second image signal to a blend unit 413 and receiving a blended result (blended image signal which will be described later) therefrom. In Exemplary Embodiment 2, the second image processing unit 404 outputs the generated second image signal to the blend unit 413, and receives a blended result (blended image signal which will be described later) therefrom. Then, the second image processing unit 404 outputs the blended image signal which the second image processing unit 404 receives, to the output selection unit 208. In addition, in Exemplary Embodiment 2, after the second image signal is generated in the second image processing unit 404, an image to be displayed on the image display unit 209 is switched to the image based on the blended image signal generated in the blend unit 413, from the image based on the first image signal generated in the first image processing unit 104. Thereby, the image to be displayed on the image display unit 209 can be gradually changed to the image based on the second image signal generated in the second image processing unit 404, from the image based on the first image signal generated in the first image processing unit 104. Incidentally, the method for switching the display is the same as that in Exemplary Embodiment 1.

The capture unit 412 has a function of outputting the obtained first image signal to the blend unit 413, in addition to the function of the capture unit 112 in Exemplary Embodiment 1.

The blend unit 413 blends the second image signal generated in the second image processing unit 404 with the first image signal generated in the first image processing unit 104, and thereby generates the blended image signal. Specifically, the blend unit 413 blends the image signals which are input from the second image processing unit 404 and from the capture unit 412, and thereby generates the blended image signal. Then, the blend unit 413 outputs the blended image signal to the second image processing unit 404.

In addition, in Exemplary Embodiment 2, the blend unit 413 gradually reduces a ratio of the first image signal in the blended image signal so that the blended image signal gradually changes to the second image signal from the first image signal.

The details of an operation of the blend unit 413 will be described later.

A delay unit 414 has a function of delaying the first image signal obtained in the image input unit 206. Specifically, the delay unit 414 performs the process of giving a delay time corresponding to a period of time necessary for a process (a process of generating blended image signal) by the blend unit 413, to the first image signal.

Incidentally, in Exemplary Embodiment 2, “synchronization of Vsync” is the process of synchronizing a vertical synchronization signal of the blended image signal generated in the blend unit 413 with a vertical synchronization signal of the image signal generated in the first image processing unit 104. The method of “synchronization of Vsync” according to Exemplary Embodiment 2 is similar to that of “synchronization of Vsync” in Exemplary Embodiment 1. Specifically, the time of occurrence Vsync of the blended image signal is determined as the time tg. Then, when tg<tdp holds, the second image processing unit 204 is controlled so that a synchronization signal of the blended image signal is delayed just for a period of time (tdp−tg). Other process is the same as that in Exemplary Embodiment 1.

In Exemplary Embodiment 2, the image to be displayed on the image display unit 209 is switched to the image based on the blended image signal, from the image based on the first image signal, in synchronization with the vertical synchronization signal of the blended image signal generated in the blend unit 413 after the synchronization process.

Note that the delay for a period of time necessary for the process by the blend unit 413 may not be given to the first image signal by the delay unit 414, but may be given thereto in “synchronization of Vsync”.

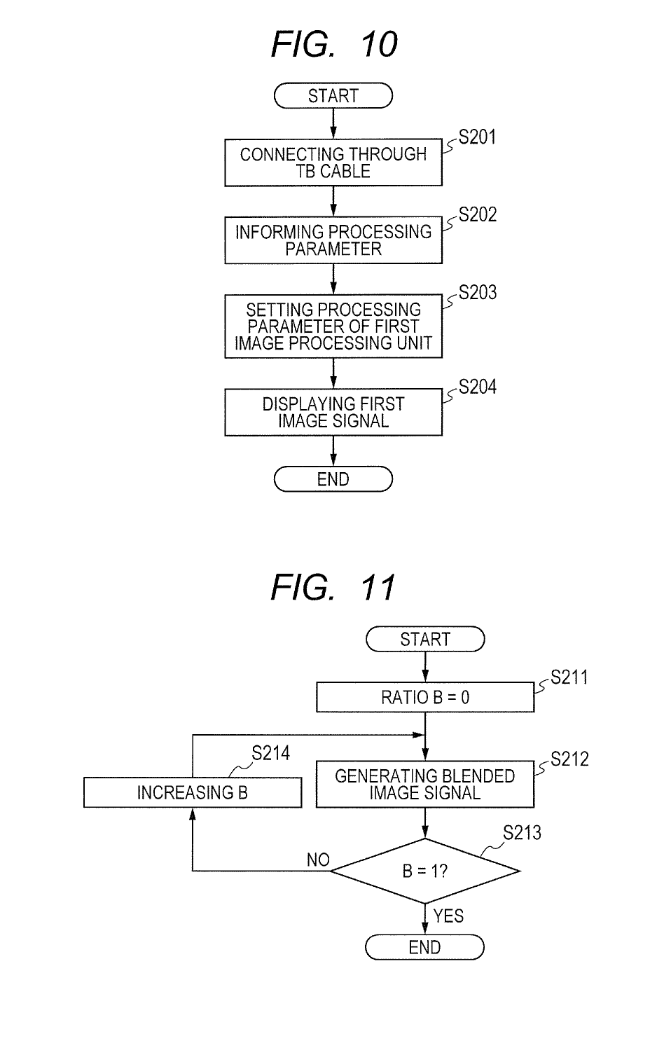

FIG. 10 is a flow chart for describing one example of an operation of the display system which is associated with a process for informing processing parameters that the second image processing unit 404 uses, to the terminal device 100.

Firstly, in S201, the terminal device 100 is connected with the display apparatus 400 by using the TB cable 300.

Next, in S202, at least one part of the processing parameters which the second image processing unit 404 uses is informed to the first control unit 101.

Then, in S203, the first control unit 101 sets the processing parameter (processing parameter informed in S202) which the second image processing unit 404 uses, as a processing parameter to be used in the first image processing unit 104. Thereby, the first image processing unit 104 can perform the generating process with the use of the processing parameter which the second image processing unit 404 uses. By making the first image processing unit 104 perform such generating process, it can be suppressed that the color and brightness of an image suddenly change, when the display is switched to the image based on the second image signal from the image based on the first image signal. Note that only when the first control unit 101 determines to use the second image processing unit 404, the first control unit 101 may make the first image processing unit 104 perform the generating process which uses the processing parameter which the second image processing unit 404 uses.

When the first image processing unit 104 generates the first image signal in accordance with the instruction from the first control unit 101, in S204, the generated first image signal is converted into a DP signal and the DP signal is output to the display apparatus 400 through the TB cable 300. The DP signal is converted into the first image signal by the image input unit 206. The first image signal is transmitted to the image display unit 209 through the output selection unit 208, and thereby the image based on the first image signal is displayed.

FIG. 11 is a flow chart for describing one example of an operation of the display system associated with the process of generating a blended image signal.

Firstly, in S211, a ratio B (ratio of second image signal in blended image signal) is initialized to 0, which is set when the first image signal generated from the image data for display is blended with the second image signal. The B is a value greater than or equal to 0 and less than or equal to 1. Specifically, in S211, the ratio of the first image signal in the blended image signal is initialized to 1.

Next, in S212, the blend unit 413 blends the first image signal with the second image signal while using the ratio B, and thereby generates the blended image signal. Specifically, the first image signal and the second image signal are blended at a ratio of first image signal to second image signal=(1−B):B. Then, the blend unit 413 outputs the generated blended image signal to the second image processing unit 404. The second image processing unit 404 outputs the blended image signal to the image display unit 209 through the output selection unit 208. Thereby, the image based on the blended image signal is displayed. In the first process, B=0 is set, and accordingly the blended image signal generated in the blend unit 413 corresponds to the first image signal. Specifically, after the first process, the display is switched to the image based on the blended image signal from the image based on the first image signal, but the blended image signal corresponds to the first image signal, and accordingly the display does not change.

Subsequently to S212, in S213, the blend unit 413 determines whether the ratio B is equal to 1 or not. If the ratio B is not 1, the blend unit 413 adds a predetermined value to the ratio B, and the process returns to S212. The process in which the blend unit 413 adds the predetermined value to the ratio B is equivalent to the process of reducing the ratio of the first image signal in the blended image signal just by a predetermined value. If the ratio B is equal to 1, the blended image signal corresponds to the second blended image signal. In this case, the blend unit 413 ends the process of generating the blended image signal. After the process of generating the blended image signal is ended, the second image processing unit 404 outputs the second image signal to the image display unit 209 through the output selection unit 208.

As described above, the display system according to Exemplary Embodiment 2 can display an image in a shorter period of time after the terminal device is connected with the display apparatus, similarly to that in Exemplary Embodiment 1, in a case where an image processing processor of the display apparatus is used for the display. Furthermore, the first image signal is generated with the use of the processing parameter which is used when the second image signal is generated. Because of this, when the display is switched to the image based on the second image signal from the image based on the first image signal, it can be suppressed that the color and brightness of the image suddenly change. In addition, the display is switched to the image based on the blended image signal from the image based on the first image signal. When the display is switched to the image based on the second image signal from the image based on the first image signal, it can be suppressed that the color and brightness of the image suddenly change.

Note that any one function may be added to Exemplary Embodiment 1, from a function of generating the first image signal with the use of the processing parameter that is used when the second image signal is generated, and a function of switching the display to the image based on the blended image signal from the image based on the first image signal.

Also note that the synchronization process may not be performed. Even in a case where the display system is configured in such a way, the above-described effect can be obtained. If the synchronization process is performed and an image is switched in synchronization with the vertical synchronization signal of the blended image signal, it can be suppressed that the display is disturbed when the image is switched.

While the present invention is described with reference to exemplary embodiments, it is to be understood that the present invention is not limited to the disclosed exemplary embodiments. The scope of the following claims is to be accorded the broadest interpretation so as to encompass all modifications and equivalent structures.

This application claims the benefit of Japanese Patent Application No. 2012-234581, filed Oct. 24, 2012, which is hereby incorporated by reference herein in its entirety.

What is claimed is:

1. A terminal device comprising:
a first image processing processor that generates a first image signal from image data;
a connection unit configured to be connectable with a display apparatus, wherein the display apparatus includes a second image processing processor which generates a second image signal from the image data; and
a control unit that controls the first image processing processor and the second image processing processor,
wherein the control unit selects one of the first image processing processor and the second image processing processor, and
wherein if the second image processing processor is selected, the control unit instructs the second image processing processor to perform a predetermined process, instructs the first image processing processor to generate the first image signal, and instructs the second image processing processor to generate the second image signal after the predetermined process is completed.

2. The terminal device according to claim 1, wherein the display apparatus and the terminal device are connected with a cable.

3. The terminal device according to claim 2, wherein the cable is a Thunderbolt cable.

4. The terminal device according to claim 1, wherein the terminal device is capable of outputting one of a DisplayPort signal and a Peripheral Component Interconnect Express signal to the display apparatus.

5. The terminal device according to claim 1, wherein the terminal device acts as a source device.

6. A display apparatus comprising:
a connection unit configured to be connectable with a terminal device, wherein the terminal device includes a first image processing processor which generates a first image signal from image data;
a second image processing processor that generates a second image signal from the image data, wherein the terminal device includes a control unit which controls the first image processing processor and the second image processing processor; and
a display unit configured to display one of an image corresponding to the first image signal and an image corresponding to the second image signal,
wherein if the second image processing processor is selected, the second image processing processor starts the execution of a predetermined process in accordance with the instruction from the control unit, and
wherein after the predetermined process is completed, the second image processing processor starts the generation of the second image signal in accordance with the instruction from the control unit.

7. The display apparatus according to claim 6, wherein the terminal device and the display apparatus are connected with a cable.

8. The display apparatus according to claim 7, wherein the cable is a Thunderbolt cable.

9. The display apparatus according to claim 6, wherein the display apparatus is capable of inputting one of a DisplayPort signal and a Peripheral Component Interconnect Express signal from the terminal device.

10. The display apparatus according to claim 6, wherein the terminal device acts as a source device.

11. A method comprising:
controlling a first image processing processor included in a terminal device and a second image processing processor included in a display apparatus, wherein the first image processing processor generates a first image signal from image data, and the second image processing processor generates a second image signal from the image data;
selecting one of the first image processing processor and the second image processing processor;
instructing the second image processing processor to perform a predetermined process if the second image processing processor is selected;
instructing the first image processing processor to generate the first image signal if the second image processing processor is selected; and
instructing the second image processing processor to generate the second image signal after the predetermined process is completed if the second image processing processor is selected.

12. The method according to claim 11, wherein the display apparatus and the terminal device are connected with a cable.

13. The method according to claim 12, wherein the cable is a Thunderbolt cable.

14. The method according to claim 11, further comprising outputting one of a DisplayPort signal and a Peripheral Component Interconnect Express signal to the display apparatus.

15. The method according to claim 11, wherein the terminal device acts as a source device.
